(19) United States
(12) Patent Application Publication
(10) Pub. No.: US 2005/0132401 A1
(43) Pub. Date: Jun. 16, 2005

(54) Method and apparatus for exchanging preferences for replaying a program on a personal video recorder

(76) Inventors: Gilles Boccon-Gibod, Los Altos, CA (US); David Bryan, (US)

Correspondence Address: GOTTLIEB RACKMAN & REISMAN PC, 270 MADISON AVENUE, 8TH FLOOR, NEW YORK, NY, 100160601, US

(21) Appl. No.: 10/733,521

(22) Filed: Dec. 10, 2003

(51) Int. Cl. H04N 7/025; H04H 9/00; G06F 3/00

(52) U.S. Cl. 725/34; 725/46; 725/35

(57) ABSTRACT

Personal video recorders (PVRs) contain many desirable features, including the ability to skip undesirable portions of a recorded broadcast program. Disclosed is a method and system for a PVR user to share with other users tags identifying desirable program portions or segments (“Hot-Spots”) and undesirable segments (“Cold-Spots”). Other users are able to either automatically or manually to adjust the replay of the program based on the tags.

### RELATED APPLICATIONS

None.

### BACKGROUND OF THE INVENTION

### FIELD OF INVENTION

This invention pertains to the control of personal video recorders (PVR). PVRs are devices used to enable recording of programs on a digital media both automatically and manually and to play back the programs. More specifically, the invention is presented that enables a user to selectively skip program portions that may be uninteresting and to repeat or slow down interesting program portions based on tags generated by other viewers and/or experts.

### BACKGROUND OF THE INVENTION

Modern technology has provided access to an ever-increasing abundance of television programs. The staggering volume of programs available from the over 200 channels of cable and satellite television, and soon, thousands of Internet sources, is both a blessing and a curse. It is a blessing to those whose interests or hobbies lend themselves to the many “narrow-cast” and special interest channels. It is a curse to those who have limited time or patience to find and watch specific programs or entertainment that they might find useful and/or appealing. In many cases, these are the same individuals.

Because of their flexibility, advanced capabilities, and ease-of-use, digital technology-based consumer devices such as personal video recorders (PVRs) and personal computers with PVR functionality have begun to provide an alternative to VCRs as a means for recording television programs in the home. These devices provide features that allow users to watch programs when they wish.

But as powerful as these devices are, they lack the ability to focus the attention of the viewer on only the most important or interesting segments of a program, and effectively avoid program segments that have little appeal (commercial messages, for example). As a result, a significant fraction of a viewers' time is still spent watching commercials and other parts of programs that are of little interest. For example, many people watch the entire evening news while interested only in the weather or sports segment. Others watch an entire sporting event, while only a few key plays are truly interesting.

For the foregoing reasons, there is a need for a method for sharing, among a group or community of television viewers, or between “experts” and viewers, information that would allow a television recording apparatus to offer the viewer the option to selectively play back only those portions of a program that were felt to be of particular interest (“Hot-Spots”), or, alternatively, play back an entire program with the exception of those portions that were felt to be particularly uninteresting (“Cold-Spots”).

### SUMMARY OF THE INVENTION

In one embodiment, one or more members of a group or community of television watchers create tag files regarding particular programs (regular series shows, movies, sporting events, and the like) that they watch. These tags files comprise tags of so-called “Hot-Spots” and “Cold-Spots”. Hot-Spots are portions of programs that were felt to be particularly interesting or valuable. Cold-Spots are portions of programs that were felt to be particularly uninteresting or worthless. In an alternate embodiment, an “expert” (television critic, subject matter specialist, commentator, etc.) creates the tag files designating the Hot-Spots and Cold-Spots of a program. These tag files may be freely distributed or offered for sale through the Internet (peer-to-peer, server-based, etc.), or a similar distribution means.

Hot-Spot and Cold-Spot tag files are created by users as they watch a television show through an appropriately equipped device (PVR, set-top box, personal computer, etc.). Users create tag files by expressing their interest in particular segments of the show by pressing selected keys on the device's remote control.

Other users, watching a delayed or recorded version of the same show through a similarly equipped device, use the tag file to alter playback of the show or display the Hot-Spots and Cold-Spots as indicators during playback. Various playback modes can be selected. These include a mode that automatically skips all of the Cold-Spots and a mode that automatically displays only the Hot-Spots or otherwise controls the playing of a program in accordance with the respective tags. The actual tags may designate a Hot-Spot or a Cold-Spot, or alternatively, they may carry a weighted value between some specific limits.

The tags are created either individually at specific PVRs and are then exchanged between watchers. Alternatively, tag files can be generated a central server and then distributed. The central server then generates the tags based on information from several PVRs and, if necessary, applies some predetermined rules to the information.

These and other features and objects of the invention will be more fully understood from the following detailed description of the embodiments, which should be read in light of the accompanying drawings.

In this respect, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The accompanying drawings, which are incorporated in and form a part of the specification, illustrate embodiments of the present invention and, together with the description, serve to explain the principles of the invention;

FIG. 1 illustrates a conventional PVR installed in a conventional scenario;

FIG. 2 illustrates a PVR that is connected to the Internet, either directly, or through a secondary device;

FIG. 3 shows a block diagram for the PVR of FIG. 2;

FIG. 4 illustrates a group of PVRs and a central server that are connected to the Internet;

FIG. 5 illustrates an exemplary data structure for storing program identifying information along with Hot-Spot and Cold-Spot tag files;

FIG. 6 is a flow chart showing how Hot-Spots and Cold-Spots are created by a user;

FIG. 7 illustrates Hot-Spot/Cold-Spot tags displayed in a binary fashion as a graphic overlay on a television screen;

FIG. 8 illustrates Hot-Spot/Cold-Spot tag files displayed in an analog fashion as a graphic overlay on a television screen; and

FIG. 9 shows several processes used to generate a composite or filtered tag file from tag files of different users.

### DETAILED DESCRIPTION OF PREFERRED EMBODIMENTS OF THE INVENTION

In describing an embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

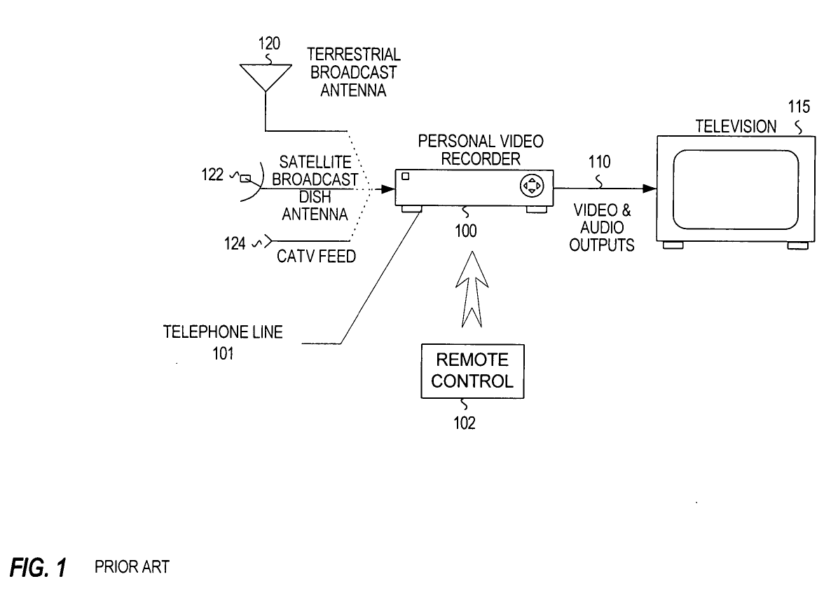

FIG. 1 shows a conventional PVR installation. Personal Video Recorder 100 receives a broadcast signal from one or more program sources. The sources of programs may include terrestrial broadcast, satellite broadcast, and cable television (CATV). These program sources are received respectively by a Terrestrial Broadcast Antenna 120, a Satellite Broadcast Dish Antenna 122, and a CATV Feed 124. A program source can comprise analog, digital or a combination of analog and digital programs. Video and Audio outputs 110 of Personal Video Recorder 100 are connected to Television 115 for user viewing of programs from Personal Video Recorder 100. Video and Audio outputs 110 may also be connected to another auxiliary device, such as a conventional videocassette recorder or digital videodisc recorder. In addition, the audio outputs may be connected to speakers (not shown) that are remote and separate from the Television 115.

The user controls the Personal Video Recorder 100 using Remote Control 102. Standard controllable functions may includes: changing channels; muting and adjusting the sound volume; pausing, fast forwarding and rewinding through programs; setting up the PVR to record programs; and selecting previously recorded programs for viewing.

In this description, a personal video recorder or a “PVR”, can refer the traditional units available from, for example, TiVo, Inc. of Alviso, Calif. and ReplayTV (Digital Networks North America, Inc) of Santa Clara, Calif. or any other media recording device or set-top box with recording capability could use the concepts contained herein.

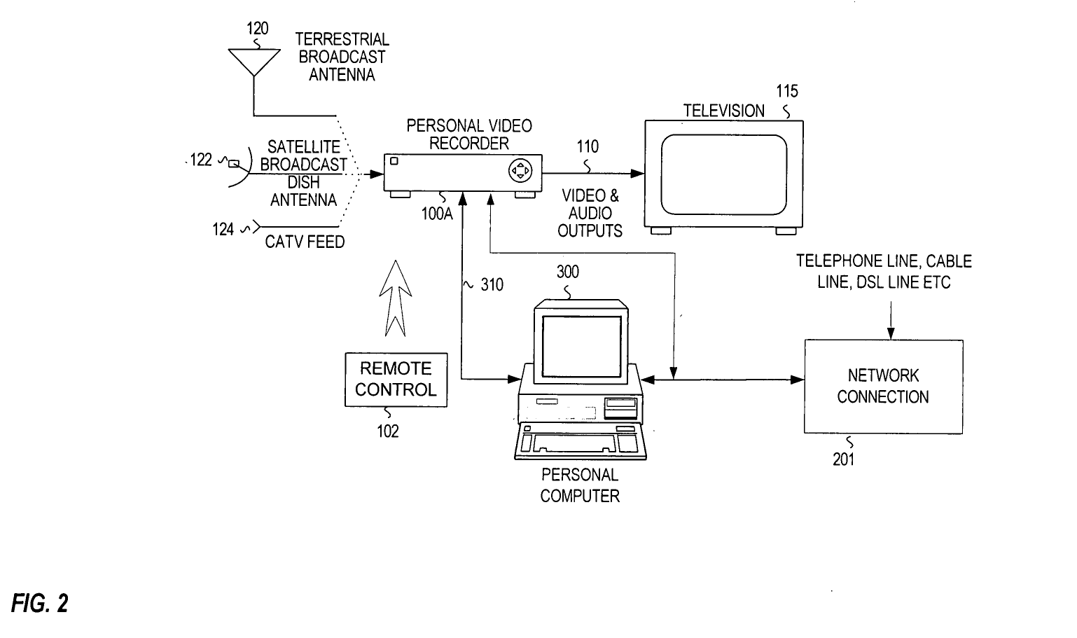

Standard PVRs include a telephone line modem (not shown) to allow the PVR to download program guide information and the like. The functionality of a PVR may be further enhanced by connecting it to the Internet to enable it to exchange information with other devices at remote sites, as discussed in more detail below. In one embodiment of the invention, the PVR itself is an Internet device, i.e., it incorporates a module (such as cable modem, WiFi adapter, etc.) that provide a direct Internet connection. FIG. 2 shows the connection of Personal Video Recorder 100A directly to the Internet through network connection 201. Alternatively, as shown in FIG. 2 the Personal Video Recorder 100A is connected to an external Internet access device such as a personal computer 300 which is, in turn, connected to the Internet through network connection 201 and transmits information between the PVR 100A and other remote devices.

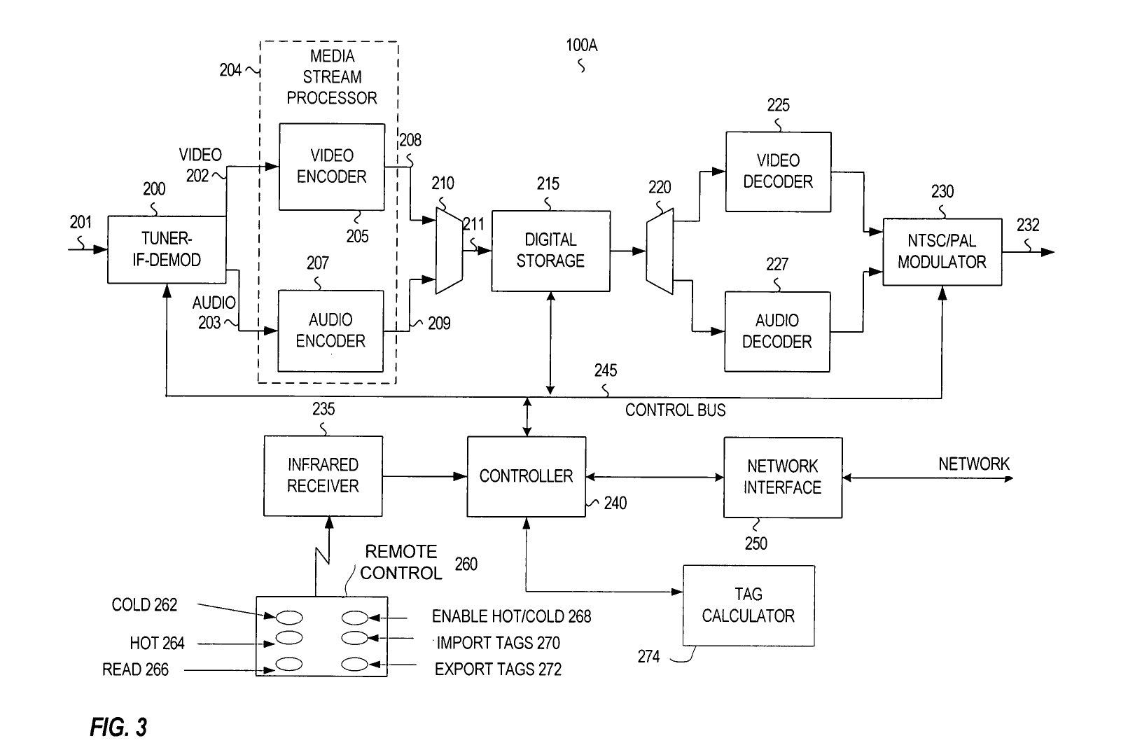

FIG. 3 is a simplified functional block diagram of Personal Video Recorder 100. The particular PVR illustrated in FIG. 3 is for use with analog television broadcasts (over-the-air or CATV, for example). The antenna/cable feed 201 is input to Tuner-IF-Demod 200. Tuner-IF-Demod 200 is the combined functionality of tuner, intermediate frequency (IF) processing, and demodulator. (When we refer, in this specification, to a “tuner”, we are typically referring to the Tuner-IF-Demod combination.) These functions serve to tune the selected channel, filter and mix the selected channel to baseband, and demodulate the received signal into video signal 202 and audio signal 203. The channel is selected by the user through an IR (infrared) remote control (not shown) through Infrared Receiver 235 and Controller 240. Controller 240 programs the channel in Tuner-IF-Demod 200 through Control Bus 245.

Video signal 202 and audio signal 203 are processed by Media Stream Processor 204, which includes Video Encoder 205 and Audio Encoder 207. Video Encoder 205 digitizes (converts from analog form into digital form) and compresses video signal 202. Video Encoder 205 may use one of the many video compression algorithms such as those included in the standards commonly known as MPEG-1, MPEG-2, or MPEG-4, or a proprietary algorithm. Audio Encoder 207 digitizes and compresses audio signal 203. Audio Encoder 207 may use one of the many audio compression algorithms such as those included in the standards commonly known as MPEG-1 (including the algorithm commonly called MP3), MPEG-2, or MPEG-4, or another algorithm. Video Encoder 205 and Audio Encoder 207 may also encrypt the media steams to protect them from unauthorized copying. The digitized video and audio signals 208 and 209 are multiplexed in multiplexer 210 and the multiplexed signal 211 is stored in a file on Digital Storage 215 under the control of Controller 240 through Control Bus 245. Digital Storage 215 may be any fixed or removable mass storage device, including a hard disk drive, an optical disk drive, flash memory, etc.

Playback comprises retrieving of a desired media file from Digital Storage 215, and demultiplexing the retrieved signals in demultiplexer 220. The demultiplexed video and audio signals are decoded by Video Decoder 225 and Audio Decoder 227. Video Decoder 225 and Audio Decoder 227 use the appropriate decompression algorithms based on those used in Video Encoder 205 and Audio Encoder 207. Video Decoder 225 and Audio Decoder 227 may also decrypt the media signals if they were encrypted during the encoding process. The outputs of Video Decoder 225 and Audio Decoder 227 are converted to a form that is appropriate for display on Television 115 by NTSC/PAL Modulator 230. The output signals 232 of NTSC/PAL Modulator 230 may include an RF modulated composite video and audio signal as well as separate video and audio signals. Separate video signals may include a baseband composite video signal, an S-Video signal, and a component video signal. Audio signals may include line level analog mono or stereo audio and S/PDIF digital audio signals.

Controller 240 is responsible for managing all of the functions of Personal Video Recorder 100A and is also responsible for managing the files on Digital Storage 215. Included in the management of the files is the monitoring of free storage space, removal of unused or unneeded files, and prioritization of storage operations. Controller 240 is also responsible for acquiring, formatting and displaying an Electronic Program Guide (EPG) on television 115. Controller 240 may acquire the data required for the EPG from information carried on the broadcast signal or by downloading data through Network Interface 250 as discussed above. The Network Interface 250 is implemented either through a telephone modem, or as a direct or indirect Internet connection as illustrated in FIG. 2.

The EPG displays a listing of current and upcoming programs on all of the available channels. The user navigates the EPG, searches for programs, and selects programs to view or record by using an IR remote control 260 through Infrared Receiver 235.

Referring again to FIG. 3, Digital Storage 215 has a read/write bandwidth that is sufficient, at a minimum, to effectively support simultaneous read and write operations. This allows a user, for example, to watch a previously recorded program while another program is being recoded.

Playback from Digital Storage 215 may be prompted by a request from the user. The user makes a playback request through an on-screen catalog of recorded programs.

In one embodiment, when a PVR user watches a television show, he/she creates information regarding his/her interest level in various segments of the show. More specifically, the IR remote control 260 is provided with a set of standard keys for generating the standard commands discussed above. In addition, the remote 260 also includes several keys provided for the selection of tags. For example, as seen in FIG. 3, the control 260 includes a ‘COLD’ key 262, a ‘HOT’ key 264, a ‘READ’ key, an ‘ENABLE HOT/COLD’ key 268, an “IMPORT TAGS’ key 270 and an ‘EXPORT TAGS’ key 272. The PVR 100A also includes a tag file generator 274.

The PVR 100A can have several modes of operation as determined by the user with the remote control 260. One mode is the standard mode in which the PVR 100A operates just like a standard PVR 100.

Another mode is a READ mode that is initiated with READ key 260. In this mode, as the user watches a program, he activates either the COLD key 282 or the HOT key 264, as described in more detail below. Activation of the either of the keys alerts the controller that a respective tag is to be generated for the portion of the program to be played. The controller 240 sends this information to the tag file generator 274 which generates a tag file. This tag file comprises tags (locations within a program) of HOT and COLD tags.

In another embodiment, instead of using the explicit commands from the user, the HOT and COLD tags are inferred from other user actions. For example, if a user replays a segment, this segment is marked as a Hot-Spot, while if a user skips a particular program segment, this is inferred to be a Cold-Spot. Using the “slow motion” feature may also mark an area as a Hot-Spot. Of course this embodiment is used only for prerecorded programs.

On some currently available PVRs, “Thumbs-Up” and “Thumb-Down” keys are provided on the remote control to enable the user to indicate their opinion of a particular show. In yet another embodiment, these keys are used to indicate Hot-Spots (Thumbs-Up) and Cold-Spots (Thumbs-Down) for segments within a show.

At the end of the program, the file is closed and the controller can either publish the file automatically, or in response to a command from the user. This command may be generated by activating the EXPORT TAGS key 272. The user can also request files for various programs by activating the IMPORT TAGS 270 key. Alternatively, the controller can import and store tag files automatically.

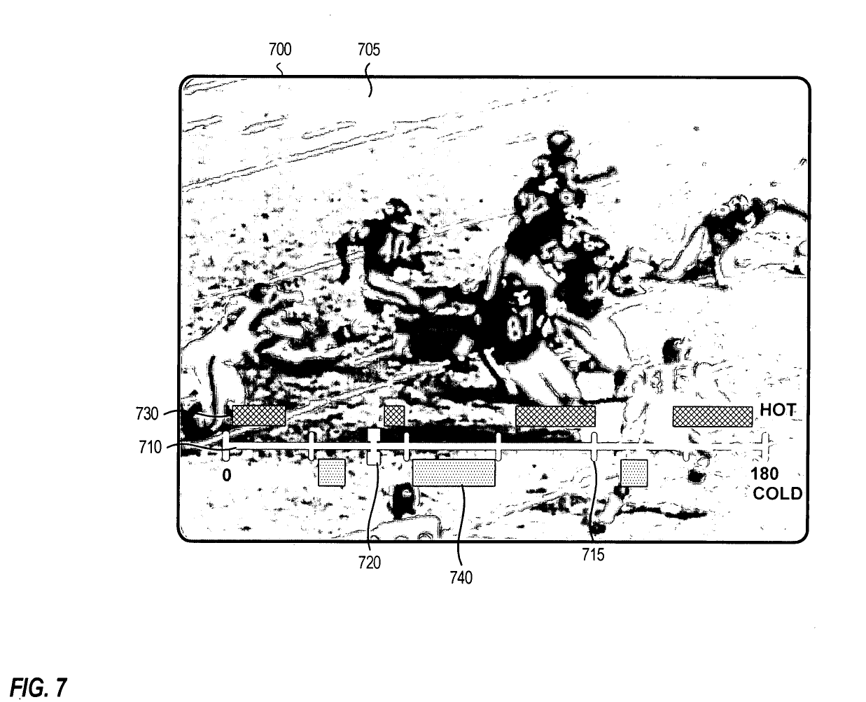

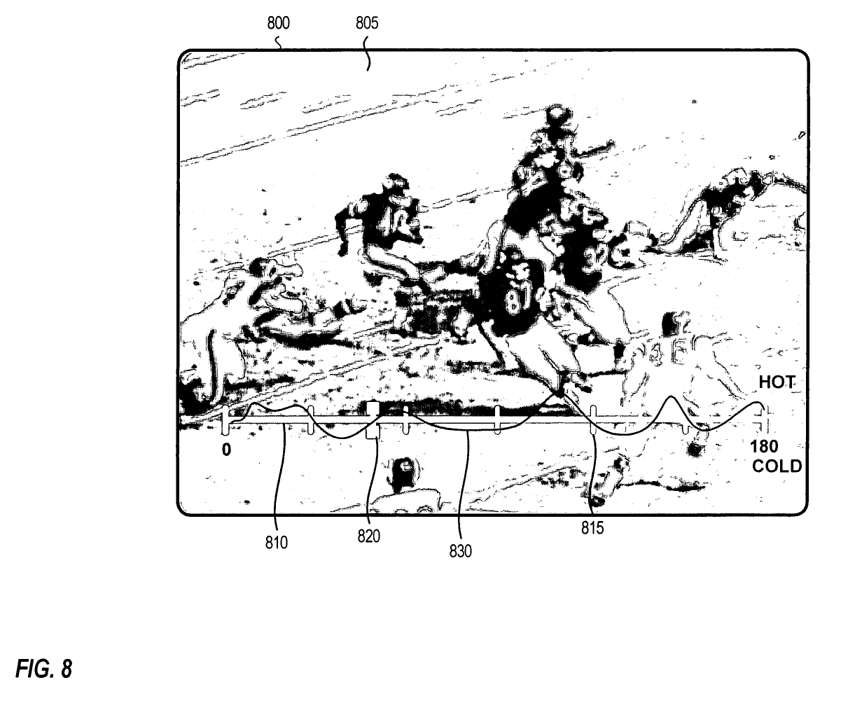

In another mode of operation, at the beginning of a program that has been prerecorded by the PVR 100A (assuming that the tag file associated with the program is available) the user pushes the ENABLE HOT/COLD key 268 and controller 240 then replays the program in accordance with the tags, as discussed in more detail below in conjunction with FIGS. 7 and 8.

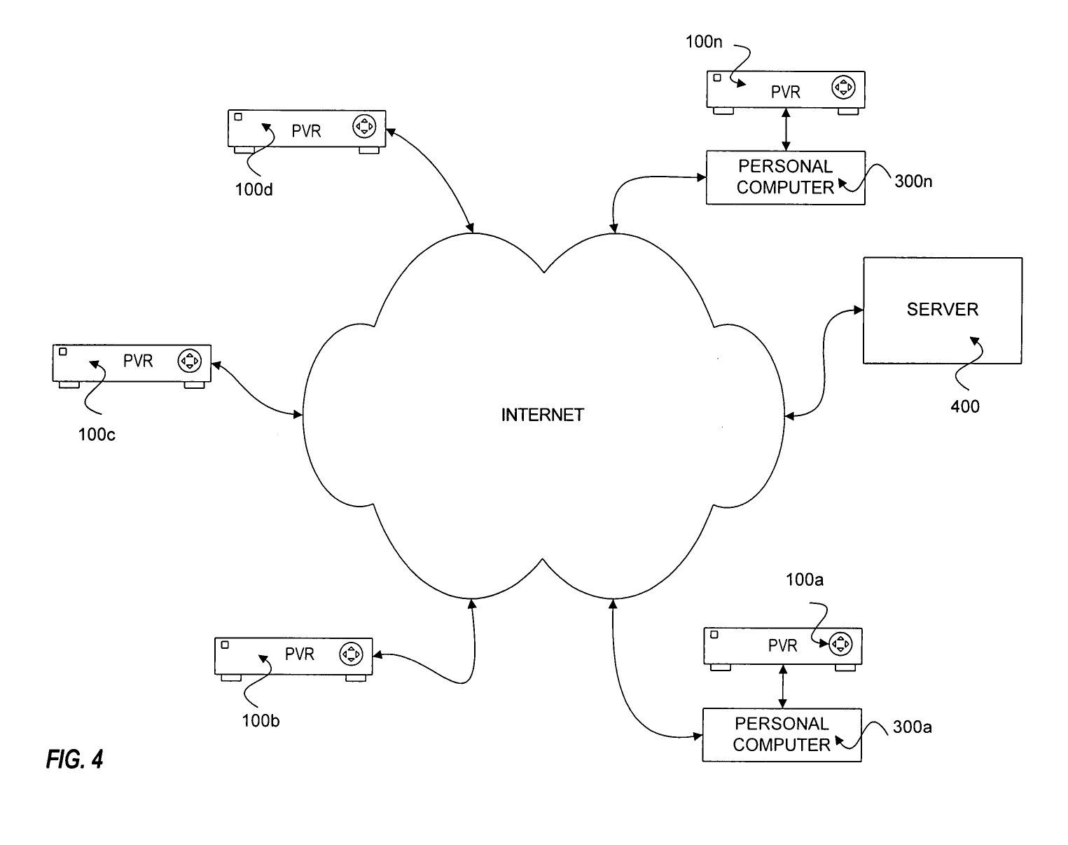

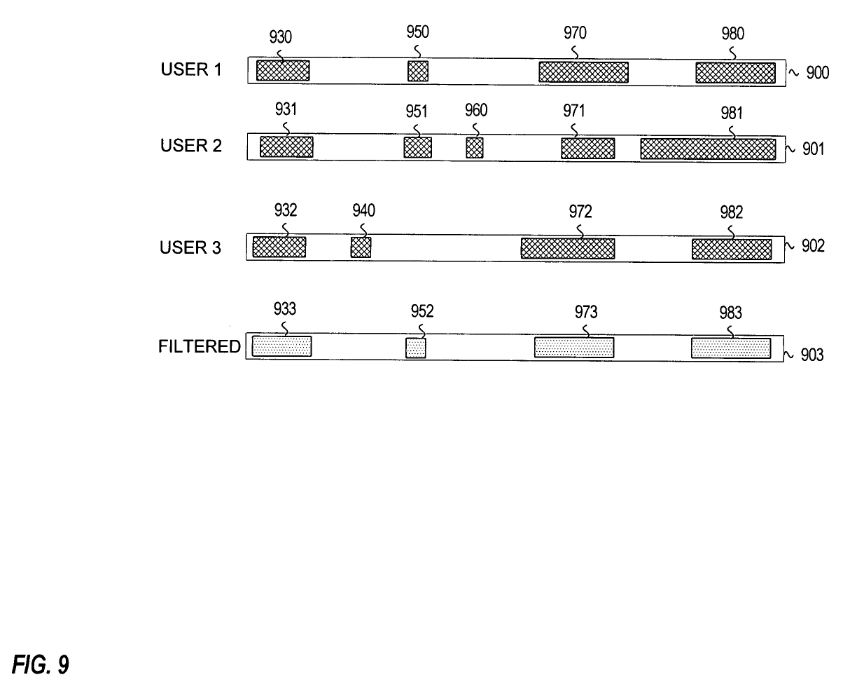

The tag files can be shared by friends and relatives or using various peer-to-peer networks. As shown in FIG. 4, a plurality of PVRs 100a, 100b, 100c . . . 100n (with or without a personal computer, such as 300n) are interconnected by a distributed computer network such as an Internet and share tag files as described. Alternatively, or in addition, a central server 400 may be provided that collects and organizes, for example, in a database, the tag files associated with different programs from the different users. Each tag file may include, but is not limited to, program title, episode number, time and date of broadcast, program rating, etc. The server may process multiple sets of tag files for each program to produce a processed or filtered set of tag files, as discussed below in conjunction with FIG. 9. This process may include removing duplicates, performing statistical operations like averaging, removal of outliers, voting, etc., or simply storing all sets of tags received for each program. The processed tag files are then published to all the users, a subset of the users, or to other users that do not provide information.

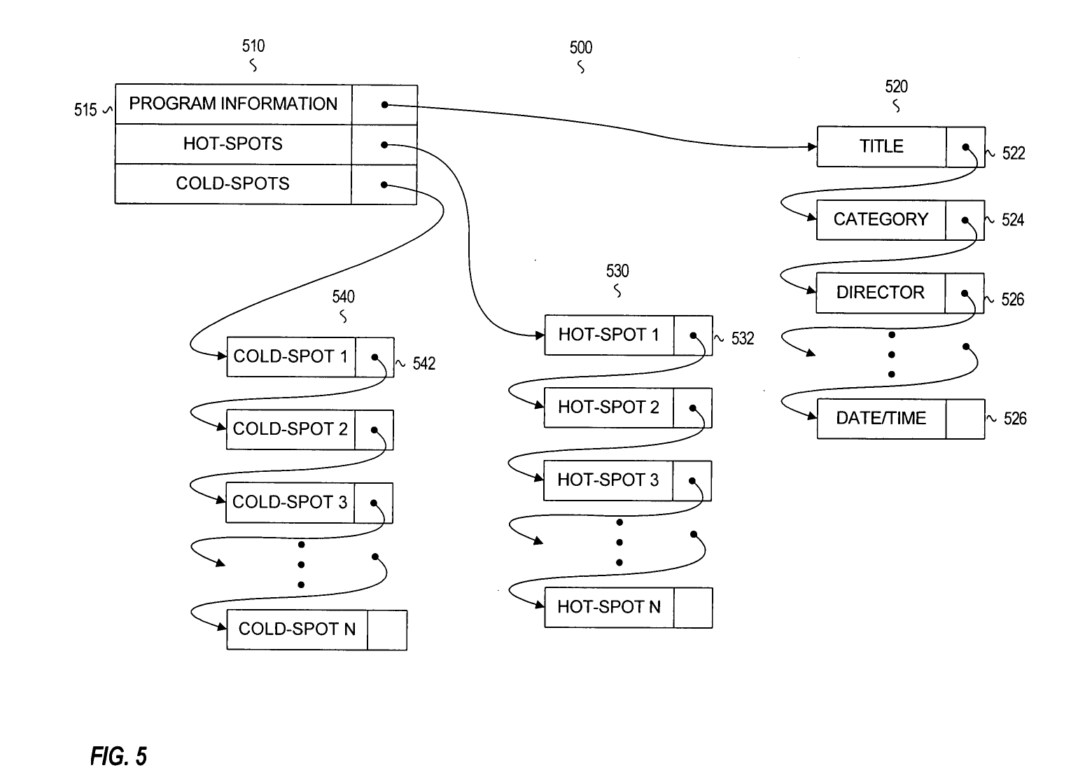

The following is a more detailed description of how tag files are created. When a user watches a show, a temporary data structure is created by the tag file generator 274. An exemplary data structure is illustrated in FIG. 5. Data structure 500 is organized as a group of linked lists. The heads of each list 510 are pointers to the list of Program Information 520, Hot-Spots 530, and Cold-Spots 540. A specific example is the Program Information head pointer 515, which points to the Title data element 522 that includes the program title and a pointer to the next data element, which in this case is the Category data element 524, which in turn points to the Director data element 526. This linking sequence ends, in the example, with the Date/Time data element 528. The Program information may also include other data elements, such as cast and crew, program rating, etc. Program category may include situation comedy, movie, sporting event, history, cooking, and the like.

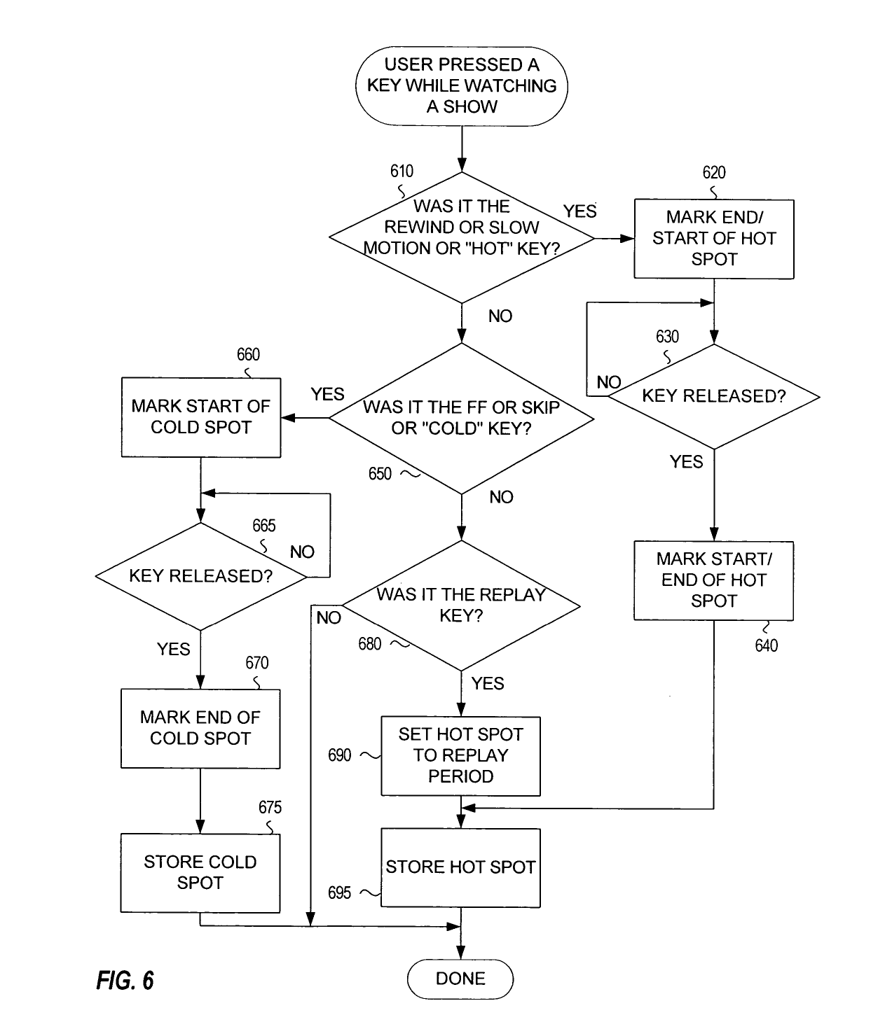

FIG. 6 is a simplified flowchart that illustrates how Hot-Spots and Cold-Spots may be created by the user during program viewing. The process described by the flowchart begins when the user presses a respective key on Remote Control 102. The process in step 610 first checks if the user pressed the Rewind, Slow Motion, or the Hot key 264. If one of these keys was pressed, in step 620 the time is marked as the beginning (in the case of the Slow Motion and Hot keys) or end (in the case of the Rewind key). The process then waits for the key to be released 630. When the key is released, the release time is marked in step 640 as either the end (in the case of the Slow Motion and Hot key) or the beginning (in the case of the Rewind key) of the Hot-Spot. The tag is stored in the temporary data structure for the program being viewed in step 695. Alternatively, if the length of the period being tagged is long, in step 630 the process ignores when the key is released and waits for the respective key to be pressed again. For example, for explicit tagging, the user can activate the HOT key to indicate the beginning of the period, and then activate the HOT key again for the end of the period.

If the user did not press the Rewind, Slow Motion, or Hot key, the process in step 650 next checks if the user pressed the Fast-Forward (FF), Skip or Cold key 650. If one of these keys was pressed, the time of the key press is marked as the start of a Cold-Spot 660. The process then waits for the key to be released 665. When the key is released, the release time is marked 670 as the end of the Cold-Spot. The Cold tag is then stored in the temporary data structure for the program being viewed in step 675.

If the user did not press the Fast-Forward (FF), Skip or Cold key in step 650, the process checks if the user pressed the Replay key in step 680. The Replay key causes the PVR to go back a fixed time period (8 seconds, for example), and automatically replay the program from that point onwards. If the Replay key was pressed, the entire replay period is marked as a Hot-Spot in step 690 and the Hot-Spot is stored in the temporary data structure for the program being viewed in step 695. If the user did not press the Replay key, the process exits with no Hot-Spot or Cold-Spot index created.

A well-known feature of the PVR is the “pause” feature, which allows the user to pause the program being viewed. Frequently, this feature is used because the viewer is distracted (e.g. by a phone call) or must temporarily leave the viewing area (e.g. get a snack). Some users may also pause a program during segments of particular interest. In one embodiment, when a user rewinds or replays a segment and pauses at a particular scene within the segment, the segment is assumed to be of particular interest and is marked as a Hot-Spot.

There are many enhancements possible to the process illustrated in FIG. 6. In one embodiment, the Hot-Spots and Cold-Spots recorded by a user include a level of interest (in the case of a Hot-Spot) or disinterest (in the case of a Cold-Spot) for a particular segment of the program. For example, conventional PVR units have several fast-forward modes. The weighting of a Cold-Spot can be based on how fast the user skips over a program segment—faster skipping would equate to lower level of interest (higher level of disinterest).

As discussed above, at the end of a program, if any Hot or Cold tags were marked by a user, the data stored in the temporary data structure is consolidated into a tag file uploaded to central server 400 or, in an alternate embodiment, shared, on a peer-to-peer basis, with other users. In another embodiment, tag files are distributed to other users (through a centralized server or in a peer-to-peer network) as soon as they are generated. In this way, a user may watch a show delayed by only a few minutes while gaining the benefit of the tag files to, for example, skip commercials, commentator banter, and other uninteresting portions of a program.

As discussed above, when multiple tag files for each program are available, the server or receiver (in the case of peer-to-peer sharing of tags) processes the tags to produce a processed tag file. FIG. 9 shows an example of how Hot-Spots for a particular program are processed in one embodiment. Tag files 900, 901, and 902 graphically represent sets of Hot or Cold tags from User 1, User 2, and User 3 respectively. Tag file 903 graphically represents a filtered or processed tag file for the same program, based on the files from User 1, User 2, and User 3. The first filtered tag 933 is generated by using the earliest start time and the latest end time of the three users. This processing is appropriate when multiple files are closely matched, and have only slight start/end time mismatches. A voting process eliminates tag 940 from User 3 and index 960 from User 2—that is, no other user has marked these spots. Preferably, this voting process is used when only a very small number of users mark a particular segment. The filtered tag 952 is generated by a combination of voting and by using the earliest start time and the latest end time of the users. The start and end times of filtered tag 973 are based on the average of tags 970, 971, and 972. This particular process is more appropriate when there are many tags for a segment, or program portion but the start and end times vary somewhat around a central mean. Tag 983 illustrates the removal of an outlier from the tags 980, 981, and 982. This process is used when most users' tags for a particular segment match well, with a small number of individual outlying user tags. It will be obvious to one skilled in the art that many other forms and modes of processing data from tag files are possible. The embodiments described herein represent only a sample of such processes.

In another embodiment, various tags are given weights. For example, a user sets certain individuals (other PVR users) as “buddies”. The tag files collected from “buddies” would be given more weight than the tags from other users. In yet another embodiment, other users would be rated based on their viewing habit similarities. This includes, but is not limited to, comparing the Hot-Spots/Cold-Spots of previously viewed programs, or the number of programs viewed in common. The tag files collected from similar users would be given more weight than the files from users who have fewer similarities. In addition, the different tags may be given weight as well. In other word, a COLD spot may be graded from 1-5 and a HOT spot may be graded from 1-5. When replaying a program a controller may be set to act only on tags having values above, or below some predetermined thresholds. In this embodiment, the server 400 is used to assign each tag a weighed value by averaging the tag values from the different users, by taking the peak value, or by using other criteria.

The tag files are used in a number of ways. In one embodiment, the tag files are displayed as a graphic overlay on the television screen as part of the playback display presented by the PVR. In one embodiment, illustrated in FIG. 7, the Hot-Spots and Cold-Spots are indicated in a binary fashion (Hot-Spot/Cold-Spot present or not). Referring to FIG. 7, television display 700 is presenting the video output 705 from the PVR, along with a graphic overlay that includes: timeline 710 for the current program with thirty minute indicators 715, current position indicator 720, Hot-Spot indicators 730 and Cold-Spot indicators 740. Using this mode, the user may manually fast-forward to skip over Cold-Spots indicated by 740 or rewind the program to replay Hot-Spots indicated by 730.

In another embodiment, illustrated in FIG. 8, the Hot-Spots and Cold-Spots are indicated in an analog fashion, wherein the magnitude of interest or lack of interest is indicated directly. Referring to FIG. 8, television display 800 is presenting the video output 805 from the PVR, along with a graphic overlay that includes: timeline 810 for the current program with thirty minute indicators 815, current position indicator 820, and Hot-Spot/Cold-Spot magnitude indicator 830. In yet another embodiment, the Hot-Spot/Cold-Spot tags are used by the PVR to automatically skip portions of the program. For example, in one mode, the PVR would be instructed to skip all Cold-Spots (for example, to skip all commercials). In another mode, the PVR would play only Hot-Spots (the highlights of a program). Many other ways of using the Hot-Spot/Cold-Spot tags to achieve a heightened user experience will be apparent to one skilled in the art, including various modes of skipping and fast-forwarding through Cold-Spots, playing and repeating Hot-Spots, etc.

In another embodiment, a group or community of television watchers, possibly with similar tastes in programming, is organized through one or more on-line community modalities, including peer-to-peer sharing, Instant Messaging, chat-rooms, Web-Logs (blogs), and other equivalent means. The individual user's PVR would perform the processing shown in FIG. 6, as described above. In this embodiment, tag files for programs are shared among members of the community with or without the use of a centralized server. The information may be shared by file transfer, instant messaging, email exchange, insertion into a blog, or other equivalent means. As these files are received, they may be processed to refine the indications of Hot-Spots and Cold-Spots as described above.

As above, when a member of the community watches a recorded program that others have already watched, and for which tag files have been received, the user's PVR, in one embodiment, displays this information on the television screen or, in an alternate embodiment, automatically uses the information to skip unwanted parts of the program. In yet another embodiment, a Hot-Spot key on the remote is used to skip to the next Hot-Spot. A member who views a program using tag files may add their own indications to the collected data, including adjustments to previous indications and new Hot-Spots and Cold-Spots.

In another embodiment, the users who create the tag files are experts. These experts may be television critics, subject matter specialists (e.g., a football coach, a sports commentator, etc.), or others with specific knowledge of particular program material. The tag files from experts may be made available in the same manner as discussed above (shared in a peer-to-peer or server-based network), or may be offered for sale or offered as part of a subscription service. An example of this embodiment is a service for watching sporting events that have been tagged and annotated by a professional coach or sports commentator. A user can view such an event in a manner similar to that of one of the team coaches. This “post-game analysis” would include instant replays, verbal commentary, as well as graphic overlays (play descriptions, field annotations, and the like) similar to that available during live broadcasts. In an alternate embodiment, equipment vendors would offer the tag files from experts as an incentive to buy their particular equipment.

The many features and advantages of the invention are apparent from the detailed specification. Thus, the appended claims are intended to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

1. A method for sharing television program-viewing experiences, the method comprising:
creating a set of tags for the segments of a viewed program indicative of the opinion of a first user; and
distributing said set of tags to a plurality of other users to allow said other users to replay said program in accordance with said tags.

2. The method of claim 1, wherein the tags are distributed via email.

3. The method of claim 1, wherein the tags are distributed through a centralized server.

4. The method of claim 1, wherein the tags are distributed through a peer-to-peer network.

5. The method of claim 1, wherein tags are applied to segments of particular interest to the first user.

6. The method of claim 1, wherein tags are applied to segments of little interest to the first user.

7. The method of claim 1, wherein the step of distributing includes providing the set of tags at no charge.

8. The method of claim 1, wherein the step of distributing includes selling the set of tags.

9. The method of claim 1, wherein the step of distributing includes providing the set of tags as a component of a subscription service.

10. The method of claim 1, further comprising the step of:
viewing the program by at least one of the other users and using the tags to alter the program playback.

11. The method of claim 10, wherein altering the program playback comprises skipping one or more segments of the program.

12. The method of claim 10, wherein altering the program playback comprises playing only one or more segments of the program.

13. The method of claim 10, wherein altering the program playback comprises playing only segments of the program that are indicated as desirable.

14. The method of claim 10, wherein altering the program playback is performed automatically by a personal video recorder.

15. The method of claim 10, wherein altering the program playback is performed selectively in accordance with commands from the other users.

16. The method of claim 10, wherein the set of tags are received by a server.

17. The method of claim 10, wherein the set of tags are received directly by the other users.

18. A method for indicating viewing preferences associated with a program to a community of PVR users, the method comprising:
creating a tag file for the program, the tag file including a plurality of tags associated with certain portions of the program, each tag indicating one of a desirable and an undesirable rating of a first user;
transmitting said tag file from at least one PVR;
receiving the tag file by a second PVR;
displaying on a TV associated with the second PVR tags from the tag file to indicate program segment viewing preferences from the first PVR.

19. The method of claim 18, wherein the second PVR receives the tag file from a network server.

20. The method of claim 18, wherein the displayed tags are used to skip portions of a viewed program.

21. The method of claim 20, wherein the skipped portions are skipped automatically by the PVR.

22. The method of claim 20, wherein the skipped portions are manually skipped by the user viewing the program.

23. The method of claim 18, wherein the displayed tags are used to indicate portions of the program that are more desirable to view.

24. The method of claim 18, wherein the displayed tags are used to indicate portions of the program that are less desirable to view.

25. The method of claim 18, wherein the displayed tags display the information in a binary format.

26. The method of claim 18, wherein the displayed tags display the information in an analog format.

27. A personal video recorder comprising:
a personal video recording unit for viewing and recording programs;
a remote control unit, including a key for sending viewer preference commands to the personal video recording unit;
a tag file generating unit for creating tags of program segments of a predetermined character based on preference commands; and
a network connection, attached to the personal video recording unit, for sharing the tag file.

28. A personal video recorder comprising:
a personal video recording unit for recording programs and playing back previously recorded programs;
a network connection, attached to the personal video recording unit, for receiving a tag file with tags associated with user preferences; and
a processing unit for adjusting playback of the personal video recording unit based on said tag file.
